(19) United States
(12) Patent Application Publication
(10) Pub. No.: US 2004/0141578 A1
(43) Pub. Date: Jul. 22, 2004

(54) Nuclear fusion reactor and method

(76) Inventor: Arthur L. Enfinger, Pensacola, FL (US)

Correspondence Address: J. Nevin Shaffer, Jr., 913 Gulf Breeze Parkway, Suite 43, Gulf Breeze, FL, 32561, US

(21) Appl. No.: 10/342,476

(22) Filed: Jan. 16, 2003

(51) Int. Cl. G21J 1/00; G21B 1/00

(52) U.S. Cl. 376/100

(57) ABSTRACT

A nuclear fusion reactor comprising a spherical reaction chamber with a mirrored interior surface filled with a nuclear fusible and laser active gaseous medium such as deuterium. Using rapid gaseous expansion caused by a focused pulsed laser source and/or timed oscillations from piezoelectric transducer, a harmonic spherical acoustic wave pattern centered within the reaction chamber is created. This wave pattern is created near a desired frequency and centered in the sphere. The wave pattern contains a central gaseous ball of high-density, pressure, and temperature that causes ionization and radiation to occur. This radiation causes the mirrored chamber to activate a spherical laser effect focused on the high pressure plasma at the center of the reaction chamber. This spherical laser pulse acting on high pressure high-density of the central standing wave produces ignition of the gas and fusion. The tremendous energy from fusion drives the acoustic process which ideally allows for a self sustaining ignition temperature plasma requiring the addition of fuel only.

### BACKGROUND OF THE INVENTION

1. Field of the Invention

This invention relates to energy production from nuclear fusion and in particular to a fusion reactor having a means for creating a spherical acoustic wave or standing wave pattern near a desired frequency and centered within a spherical mirrored reaction chamber. Radiation produced by intense heat as the waves focus and reinforce at the center of the reaction chamber will produce a spherical laser effect. The chamber becomes a self-contained pulsed spherical laser focused at the central acoustically compressed gas starting the fusion process.

This invention is disclosed in my Disclosure Document No. 481620 filed Oct. 23, 2000.

2. Background of the Invention

Controlled nuclear fusion has been a goal of scientists for several decades with billions of dollars spent to develop this energy resource. Two reactor types currently under large scale research and development involve the use of magnetic plasma containment and inertial laser ablation.

The major problem experienced with magnetic containment is maintaining effective plasma containment at ignition temperatures. Inertial ablation uses a laser pulse focused on small encapsulated fuel targets to reach efficient fusion temperatures and densities. Problems with its present stage of development are associated with the complicated and cumbersome mechanics required for aiming and firing the lasers, the enormous energy needed to supply the lasers, energy recovery, and neutron damage. While these two types of fusion reactors can eventually work, neither is adaptable for small scale energy production.

Another fusion device presently being developed involves the use of an electromagnetic standing wave called a fundamental electromagnetotoroid singularity. This device accelerates deuterons in close parallel trajectories allowing magnetic attraction to overcome electrostatic repulsion resulting in fusion. This technology is scalable, does not require heat and can produce electricity directly.

U.S. Pat. No. 5,818,891, issued to Rayburn et al., entitled “ELECTROSTATIC CONTAINMENT FUSION GENERATOR”, discloses a fusion generator that includes a chamber having two pairs of spaced apart permanent magnets. An ion source provides a deuteron beam to enter into a figure 8-orbit between the two pairs of magnets.

U.S. Pat. No. 5,160,695, issued to Bussard, entitled “METHOD AND APPARATUS FOR CREATING AND CONTROLLING NUCLEAR FUSION REACTIONS”, discloses a reactor having a core made of surface-packed quasi-conical honeycomb ion density structures.

U.S. Pat. No. 4,333,796, issued to Flynn, entitled “METHOD OF GENERATING ENERGY BY ACOUSTICALLY INDUCED CAVITATION FUSION AND REACTOR THEREFOR”, discloses a fusion reactor having two chambers each filled with a liquid (host) metal.

U.S. Pat. No. 4,182,651, issued to Fisher, entitled “PULSED DEUTERIUM LITHIUM NUCLEAR REACTOR”, discloses a reactor that burns hydrogen bomb material in a fusion reactor chamber.

U.S. Pat. No. 3,562,530, issued to Consoll, entitled “METHOD AND APPARATUS OF PRODUCTION OF NONCONTAMINATED PLASMOIDS”, discloses in one embodiment, an explosive sphere that triggers an explosion via laser beam projected onto a target such as a fragment of deuterium or a mixture of deuterium and tritium in a solid state in order for a vacuum to be maintained in the chamber.

U.S. Pat. No. 3,378,446, issued to Whittlesey, entitled “APPARATUS USING LASERS TO TRIGGER THERMONUCLEAR REACTIONS”, discloses an apparatus having a chamber that receives laser pulses in evacuated space. The apparatus utilizes small thermonuclear plasma explosions to generate electric energy.

In view of the foregoing, the present invention is a fusion device that uses a spherical acoustic wave or standing wave pattern centered within a spherical chamber to produce, at its central focus, intense pressure and density with accompanying radiation. The mirrored reactor chamber is a spherical laser resonator and this radiation activates a spherical laser pulse that focuses on the high pressure gas produced at the reactor's center causing fusion ignition.

As will be seen more fully below, the present invention is substantially different in structure, methodology and approach from that of the prior fusion reactors and solves the problems with other reactors in a unique way.

### SUMMARY OF THE INVENTION

Broadly, the present invention is a fusion reactor comprised of a spherical reaction chamber having a spherical mirrored inner surface and means for creating a spherical acoustic wave or standing wave pattern at or near a desired frequency and centered within the reaction chamber. Ionization and radiation from the intense adiabatic compressions of the focused acoustic waves activates spherical laser pulses which focus on this high-density gas produced at the reaction chamber center.

The spherical acoustic waves are created at or near a selected frequency and period by an external pulsed laser beam focused at the center of the chamber through a window in the chamber wall and/or oscillations of a piezoelectric transducer assembly lining the chamber sphere wall inner surface. These means for creating and maintaining the spherical acoustic waves can be controlled by a master controller using feedback from radiation and ultrasonic sensors.

Moreover, the present invention contemplates a method of creating a fusion reaction comprised of the following steps.

1. The reaction chamber is filled with a nuclear fusible gas which is also a laser active medium, such as deuterium.

2. The external pulsed laser is activated and/or the piezoelectric layer is oscillated at a desired frequency to create a spherical acoustic wave or standing wave pattern centered within the reaction chamber. Each drive can be timed, by using sensor feedback, to add energy to the acoustic wave as it reinforces at its respective drive area.

3. Acoustic focusing and reinforcement at the center of the reaction chamber causes adiabatic compressions of the gas producing intense heat and density with accompanying ionization and radiation.

4. The spherical mirrored chamber is a spherical laser resonator. Radiation from this ionization within the chamber causes a spherical laser pulse to develop, focused on the spherical high-density acoustically compressed gas centered within the chamber. This intense energy focused on the high-density nuclear fusible gaseous medium is the ultimate method of achieving ignition in this reactor. Once started, the energy from fusion directly assists in driving the acoustic waves for a system that can be tuned and controlled.

In view of the above, the object of the present invention is to provide a fusion reactor that is scalable from about one-half to three meters in diameter and produces heat that can be converted to work and, in some configurations, is able to produce electricity directly. This reactor is ideal to power vehicles large and small, produce electricity, and could be used in space travel.

### BRIEF DESCRIPTION OF THE DRAWINGS

For a further understanding of the nature and objects of the present invention, reference should be made to the following description, taken in conjunction with the accompanying drawings in which like parts are given like reference numerals and, wherein:

FIG. 1 illustrates a cross-sectional view of a combination laser and piezoelectric driven fusion reactor in accordance with the present invention;

FIG. 2 illustrates a cross-sectional view of a laser driven fusion reactor in accordance with the present invention;

FIG. 3 illustrates a cross-sectional view of a piezoelectric driven fusion reactor in accordance with the present invention;

FIG. 4 is a graph that illustrates the intense increase in pressure caused by converging spherical acoustic waves. The graph is of an equation presented in the text and shows the pressure distribution for a spherical acoustic standing wave pattern similar to the example described.

### DETAILED DESCRIPTION OF THE PREFERRED EMBODIMENT

The reactor's spherical mirrored reaction chamber is assembled on the inner surface of a hollow sphere. The interior of the reaction chamber sphere, when assembled with all installed and applied components, should form and complete a spherical inner surface for the reaction chamber. Spherical symmetry is required to create and maintain spherical acoustic waves centered within the chamber. Precise spherical symmetry and mirroring are required to generate spherical laser pulses within the chamber. To create the acoustic waves, the reactor employs one or more pulsed laser beams focused at the center of the chamber and/or any arrangement of a piezoelectric transducer or transducers bonded to the chamber sphere's inner wall.

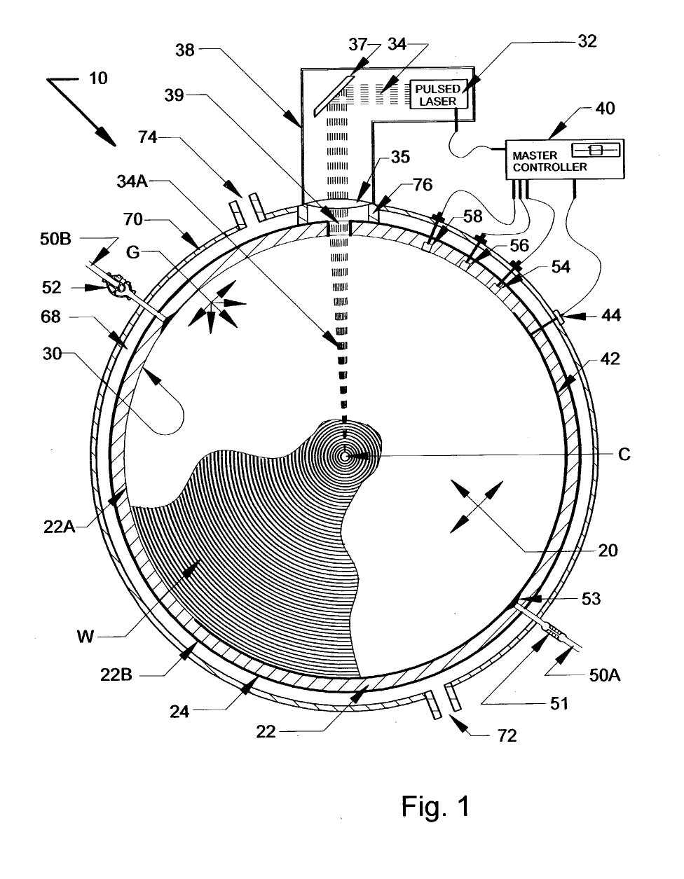

Referring now to the drawings and in particular FIG. 1, the combination laser and piezoelectric driven fusion reactor of the present invention is generally referenced by the numeral 10. The fusion reactor 10 includes a spherical reaction chamber 20 formed by the assembled spherical inner surface 22A. The reaction chamber sphere wall 22 and inner surfaces may be machined or molded as one piece or as hemispheres or parts to be fastened together. It may be made of metal, ceramic or some other suitably dense and rigid material able to withstand and transmit heat. Neutron shielding 24 is necessary and may be incorporated as an outer layer of the chamber sphere wall forming the sphere wall outer surface 22B. The external pulsed laser 32 and the piezoelectric transducer 42 are the means for creating a spherical acoustic wave pattern W, which includes spherical acoustic standing wave patterns, centered within the spherical reaction chamber 20.

The pulsed laser beam 34 travels through a neutron shielded conduit 38 and is reflected at the angled laser mirror 37 through the lens 35 resulting in a focused pulsed laser beam 34A traveling through the laser window 39 focused at the reaction chamber center C. The inner surface of the laser window should be ground, polished, and mounted in the sphere wall 22 to match the radius of curvature of the spherical inner surface 22A of the reaction chamber and complete its spherical symmetry. As a window, it may be of uniform radial thickness so that radiation focused at the center of the reactor will pass through it without refraction and remain focused at the chamber center. The laser window should be sufficiently thick and strong and dense to reflect sonic energy and to withstand pressure. It must be heat tolerant and if necessary it can be hollow or fashioned in two parts as an inner and outer window with a space in between to incorporate a pumped fluid cooling system.

Monitoring the cyclic radiation level within the reaction chamber will allow the master controller 40 to time the laser pulses to synchronously coincide with the maximum pressure and ionization of the central focused acoustic wave. Radiation level feedback may be direct feedback through the pulsed laser or from a radiation sensor 54 in the sphere wall at the reaction chamber inner surface 22A or through a small window in the sphere wall mounted flush with the chamber inner surface 22A. This acoustic drive timing builds the waves to high energy and maintains them at a harmonic frequency of the sphere. A requirement for the laser and its pumping or its switching device is that it be able to adjust rapidly to the minute changes in the frequency and period of the waves expected during operation and especially at startup and as the reactor reaches operating temperature. The pulse frequency may be any frequency maintaining at least one energetic acoustic wave within the reaction chamber to frequencies in the megahertz range. Pulse duration may be any short pulse or extremely short pulse. A variety of relatively low power adaptable laser oscillator systems is available to supply pulsed laser power to heat or ionize a specific gas, when focused, to power this reactor. A combination of optical pumping, or other means, possibly in conjunction with an acoustooptic coupler, electrooptical or other device may be used to q-switch or produce a pulsed laser oscillator with the selected frequency and pulse duration range. Multiple lasers or higher power lasers with a beamsplitter and multiple windows would probably be needed for larger reactors. Excess energy in the focused laser beam would directly contribute to achieving fusion temperatures and population inversion. Other pulsed focused energy beams should also be able to power this reactor.

Referring again to FIG. 1, the piezoelectric transducer 42 will cover part or all of the available inner sphere wall with the exception of the laser window 39 and any installed sensors. With the exception of the laser window 39 and the radiation sensor 54, the entire interior surface of the reaction chamber, including the piezoelectric transducer area, has a uniform coating of a high performance laser mirroring 30 applied to complete its portion of the reaction chamber spherical inner surface 22A. This mirroring should reflect light, ultraviolet, infrared and possibly other electromagnetic radiation. A piezoelectric transducer assembly that only covers part of the reaction chamber sphere's inner surface is recessed into the inner sphere wall so that the inner surface of the mirroring on the piezoelectric transducer will form the reaction chamber inner surface 22A. Care should be taken in the deposition or molding of the piezoelectric material to adapt techniques to produce a uniformly thick layer which is radially polarized. The piezoelectric electrode layer or layers should also be uniformly applied or deposited. Electrification of the piezoelectric element area would be by electrodes 44 through as many holes as are required in the sphere wall. The holes should be sealed with a suitable electrical insulating substance, which can withstand the moderately high temperatures expected at the sphere wall. Piezoelectric elements, such as bismuth titanate, are able to operate at up to 500° C., while remaining responsive over a broad frequency range. Piezoelectric performance in a gas can be improved by using ultrasonic frequencies or periods, stacked piezoelectric elements, whose natural resonance is near the frequency utilized, and also by using square wave pulsed electrical power. Piezoelectric power coupling also improves with each pass of the enhanced acoustic pressure wave. Direct feedback from the piezoelectric transducer or from an ultrasonic sensor 58 at the chamber inner surface, allows the piezoelectric displacements to be timed to add energy to the waves as they reinforce there. This timing of the piezoelectric acoustic drive in unison with the pulsed focused laser acoustic drive builds the waves to high energy and maintains them at a harmonic acoustic frequency of the sphere.

The high efficiency mirroring used may be metal, metal dielectric or dielectric depending on the temperatures and radiation expected in the particular reactor operating system. Reflective electroplating or polishing may also be used for the chamber's inner surface. If back reflection from the mirrored chamber wall incident to the focused pulsed laser beam 34A interferes with laser operation, that area may be faceted to disperse or scatter radiation without significantly affecting the spherical acoustic properties of the reactor. This region may also be kept free of piezoelectric elements due to any additional temperature burden which may result.

A cooling jacket 70 around the reaction chamber sphere wall 22 is needed to control sphere wall temperatures. The cooling jacket 70 includes at least one inlet port 72 and outlet port 74 for the circulation of cooling fluid 68 in the gap between the cooling jacket 70 and the chamber sphere wall outer surface 22B. The cooling circuit may be used to supply heat or to power a turbine, or other system to do mechanical work. The cooling jacket may be secured by multiple flanges. One flange 76 would also provide a sealed opening to prevent obstructing the window 39. Feedback from a thermal sensor 56 in the chamber sphere wall could cause the master controller to stop or slow the reactor if chamber wall cooling was insufficient.

The reaction chamber is filled with a nuclear fusible gas G which is also a laser active medium, such as deuterium. Deuterium is chosen here for illustration and simplicity of discussion only. Other gases or mixtures of gases, which might include tritium, deuterium fluoride, and helium are possible, as are combinations with gases that facilitate or change laser activity such as the inert gases argon and xenon. Any configuration or arrangement, one or more, of a gas inlet 50A and outlet 50B each with a diffuser 53 flush with the chamber's inner surface would allow for replenishment of the gas and removal of by products with minimal disruption of the 20 acoustic wave pattern. A deuterium source and regulator 51 at the gas inlet port would control replenishment of the gas. A vacuum pump 52 is connected to the gas outlet to maintain the desired chamber pressure and to exhaust partially used gas.

An impulsively and/or harmonically driven spherical acoustic wave pattern W, which may be a standing wave pattern, centered within the mirrored sphere, is produced at or near a desired frequency and period. The reactor can operate by producing energetic spherical acoustic waves of short period, singly or in a series, which attenuate substantially as they reinforce at the center C. The reactor can also operate by acoustically pumping and maintaining at high energy at least one spherical acoustic wave within the reaction chamber. This allows operation of the reactor at relatively low frequencies. Alternatively multiple waves or a full compliment of waves produced at or near a selected frequency may be maintained within the reaction chamber to produce spherical acoustic standing waves.

Spherical acoustic standing waves are the product of superposed inwardly and outwardly traveling spherical acoustic waves. Such standing waves may be established by the outwardly traveling waves produced by the acoustic drive of the focused pulsed laser beam 34A, focused at the reaction chamber center C, which causes periodic rapid gaseous heating and expansion or by the converging spherical waves produced by oscillations of a piezoelectric transducer on the inner surface of the reaction chamber. These acoustic waves do not interfere with the focused pulsed laser beam 34A since the radially focused beam intersects them at right angles without refraction. Both drives are used in unison by utilizing sensor feedback through a master controller 40 to add energy to the acoustic wave as it reinforces at its inner or outer pumping area.

At maximum pressure reinforcement these standing waves form stationary concentric spherical pressure waves. Similar concentric “shells” of relative negative pressure separate them. One-half cycle later, at the next reinforcement, the positions of the reinforced pressure waves and the negative pressure shells are reversed with a high pressure spherical or ball-shaped region centered within the wave pattern appearing once every cycle. One-fourth cycle after any acoustic reinforcement the gas is in a state of kinetic flux with equal average particle distance and equal pressure throughout the chamber.

At reinforcement the spherical acoustic standing waves have enhanced pressures and velocity distributions and temperature which are inversely related to the distance of the wave from the center of the wave pattern. This geometry places the most significant pressure and temperature increases of the wave pattern directly in the center of the reaction chamber 20. Here sudden intense adiabatic compression causes heating of the gas to high temperature, causing molecular dissociation and radiant energy production from single and multi-photon ionization with each pressure oscillation at the reactor's central focused region.

The reaction chamber is a spherical laser resonator where the only reinforcable path radiation can take is the radial path through the chamber center C and perpendicularly incident to the mirrored inner surface 30 of the reaction chamber. Once the spherical acoustic wave pattern is established, centered within the reactor chamber, the radial path is the only non-oblique, refraction-free and reinforcable path for radiation through these spherical pressure waves. This path through the reaction chamber center 20 has opposed tangentially parallel laser mirroring 30 along every available axis. A preferred configuration for gas lasers is for both mirrors to exhibit a radius of curvature of one-half their separation, a condition met in the mirrored interior of this reaction chamber 20. This reactor's spherically shaped gaseous gain medium G would produce stimulated emission equally in all directions with the net result a slight increase in the intensity of the light for a slightly shorter duration than would occur if gain were not present. Population inversion of the lasing medium in the chamber may be established through optical pumping with the radiation produced by the diverse array of reactions including ionization and fusion in combination with energetic particle collisions. With sufficient radiation within the spherical mirrored reaction chamber 20 to effect population inversion this must create what can be termed a spherical laser effect. Because the primary excitation process of the gas medium is an acoustic pressure oscillation, the operation of this reactor can be termed an acoustically pumped spherical laser. The spherical laser would focus precisely and intensely on the core of the spherical high-density wave at the center of the reaction chamber C. These synchronously generated spherical laser pulses temporally and spatially coincide and focus with complete coverage on the central ball-shaped high pressure gas wave at the spheres center causing ignition. Once fusion temperatures are reached in the central region, high energy nuclei within will collide with fusion resulting. Since this fusion occurs near maximum acoustic wave reinforcement, its energy, and any secondary radiation release, further energizes and pressurizes the partially ionized central wave pattern, which results in a more forceful expansion phase. This process drives the standing wave pattern and ideally allows for the creation of a self-sustaining or near self-sustaining fusion-driven recurring ignition temperature plasma.

In this system the radiation and localized energy in the central region transform back into kinetic energy as the gas expands, by randomization among all accessible degrees of freedom. This allows repetition of the compression and radiation phase over many cycles without appreciable loss. This plasma region can be made to occur thousands of times per second and only the small amount of energy lost by the system during one cycle need be replaced through fusion for a self-sustaining or near self-sustaining recurring plasma. This overcomes the high-density requirement placed on inertial laser ablation methods where all of the energy of compression and energy loss due to scattering and other inefficiencies must be produced and then recovered. Problems with ignited plasma containment are also overcome in this reactor system. The compact plasma forms under total three dimensional control in physical and thermal isolation with reflective radiation insulation and exists for only an instant with subsequent radiation and expansion a part of the process of its formation.

The energy produced by fusion heats up the entire gas in the chamber. This energy can then be extracted by the cooling jacket and utilized for practical purposes. Piezoelectric elements are efficient producers of electricity when exposed to ultrasonic waves and a reactor using a piezoelectric transducer element can produce electricity directly in addition to cooling the outer acoustic wave. By monitoring the radiation level in the chamber and secondarily the sphere wall temperature an active feedback circuit can allow control of the reactor power level and also keep it within maximum and minimum limits by adjusting the power or timing of the exciting laser energy and/or the piezoelectric driver system. Power output for a reactor operating at a certain acoustic frequency and gas pressure could be immediately increased by increasing the intensity or the number of the acoustic waves in the reaction chamber 20. Operating a reactor at maximum drive without controls would quickly destroy the mirroring and partially melt the sphere wall as heat and radiation become too intense.

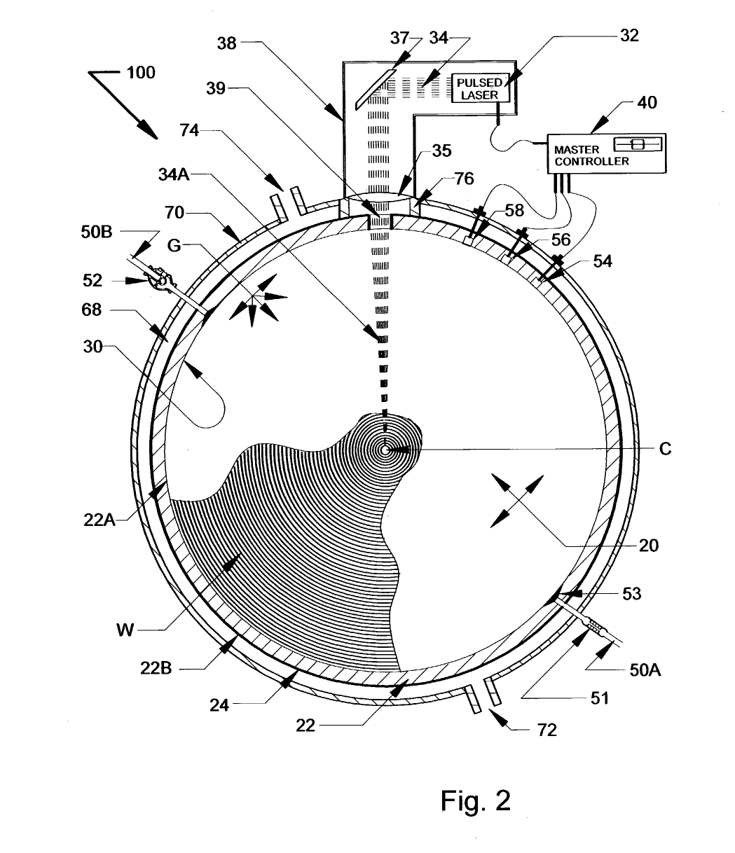

Referring to the drawings, FIG. 2 depicts a laser driven fusion reactor generally referenced by the numeral 100. This is an alternative embodiment of the present invention that utilizes only the focused pulsed laser beam 34A, focused at the center of the reaction chamber C to produce the spherical acoustic waves W and drive the reactor. Like parts retain like numbers and theory and principles involved remain the same.

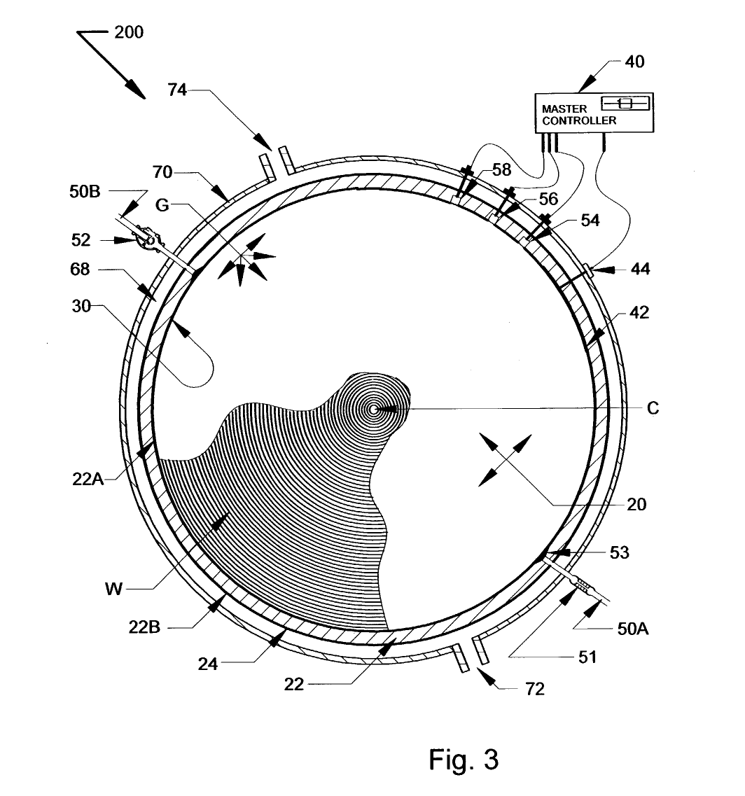

Referring to the drawings, FIG. 3 depicts a piezoelectric driven fusion reactor generally referenced by the numeral 200. This is an alternative embodiment of the present invention that utilizes only the piezoelectric transducer 42 covering all the available inner surface of the chamber sphere to produce the spherical acoustic waves W and drive the reactor. Like parts retain like numbers and theory and principles involved remain the same.

Numerous modifications known to those skilled in the art may be applied to this reactor system without departing from the scope of this invention.

### EXAMPLE

The following example describes the operation of a full-coverage piezoelectric driven fusion reactor with a reaction chamber two meters in diameter and similar in configuration to the reactor depicted by FIG. 3. The reaction chamber at start up contains deuterium at a pressure of 10 torr and a temperature of 300° K. The speed of sound within the reactor chamber is about 930 m/s. Operating the piezoelectric drive at 100,000 Hz produces an acoustic wavelength of 0.93 cm. The converging forward pressure wave produced at the inner surface 22A has a depth in its direction of travel of one-half wavelength (0.465 cm). This forward pressure wave propagates inward, with constant speed, wavelength, and energy, and reinforces itself as a spherical pressure wave one-half wavelength in diameter (radius is 0.2325 cm) as it passes through the chamber center C. By comparing the volume of this wave at the chamber inner surface 22A, with its spherical volume as it reinforces at the center C, the approximate ratio of their energy densities or pressures can be determined. The volume of this pressure wave at the inner surface 22A is approximated by the following equation:

Wave volume=(Wave depth)(chamber inner surface area) Eq(1)

For this case, the wave volume is (λ/₂)(4π(100 cm)²) or equal to 5.86×10⁴ cm³. The volume of the spherical wave at the chamber center C is:

Cent Wave Vol=4/3π(radius)³ or 4/3π(λ/₄)³.

In this example, the center wave volume is 4.19(0.2325 cm)³ or equal to 5.26×10⁻² cm³. For the reactor in this example the energy density ratio is 5.86×10⁴ cm³/5.26×10^{31 2} cm³ or equal to 1.1×10⁶. Applying this ratio to an ideal gas behavior in the reactor example, the pressure at the chamber center 20 would be over one million times greater than that generated at the chamber inner surface 22A.

If the reactor in this example operated with piezoelectric transducer displacements of 1×10⁻⁴ cm every one-half period, the approximate averaged pressure increase over this forward wave would be, 1×10⁻⁴ cm/λ/₂ (10 torr)=1×10⁻⁴ cm/0.465 cm (10 torr)=2.15×10⁻³ torr. Using the energy density ratio, 1.1×10⁶ we can calculate the averaged pressure produced as this wave reinforces at the center to be 1.1×10⁶×2.15×10⁻³ torr≅2.37×10³ torr. This is an increase in pressure to 237 times the starting pressure, which corresponds to an increase in temperature for an ideal gas to 71,000° K.

Since the energy density ratio was calculated based only on reaction chamber size and acoustic wavelength, this ratio is independent of reactor start-up pressure. Since adiabatic temperature changes are primarily a function of the ratio of the initial pressure and the final pressure, which are set for a particular reactor, the temperature increase achieved at the reaction chamber center would also be essentially constant for any starting pressure. Thus the amount of radiation produced is proportional to the amount of gas in the reactor. This means population inversion and laser activity is also independent of starting pressure. Since intense radiation and heat are produced within the chamber sphere and cooling of the reactor chamber wall is a major concern, a lower pressure of 1 to 10 torr, in the standard range for hydrogen lasers, would reduce the radiation level, fusion rate, and also the rate at which heat must be transmitted through the chamber wall.

The pressure distribution within the spherical acoustic standing wave for this reactor are more precisely described by the zeroth order Bessel function;

p=2A sin(K r)cos(ωτ)/r, Eq(3)

or as

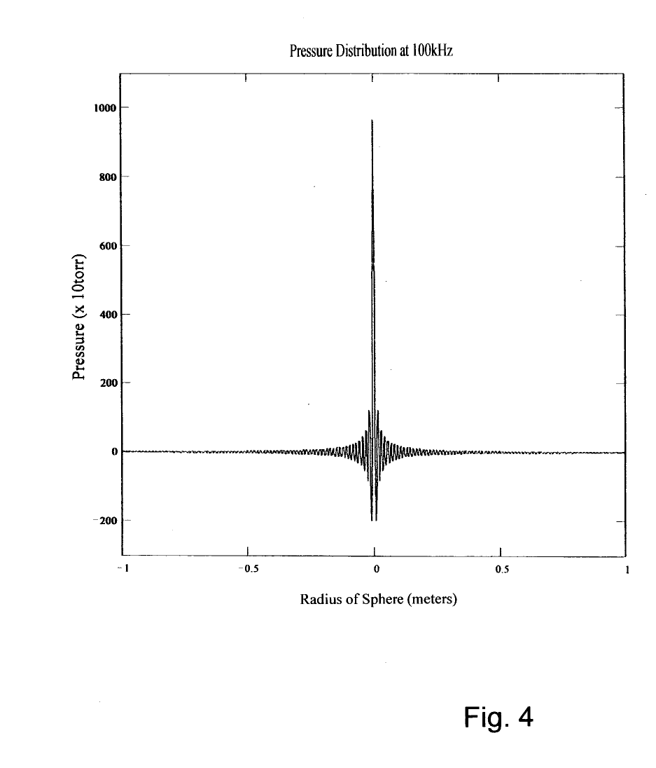

p=4πA² cos²(ωτ)/ρ₀c, Eq(4)

where K is 2π/λ, p is pressure, A the beginning amplitude, ω is the angular frequency (=2πfreq.), τis time, and ρ₀ is the density of the gas, c is the speed of sound through the gas, and r is the radius. FIG. 4 is a graph a derivation of these equations for the reactor described in the example for the first acoustic pass at startup using a sinusoidal wave form piezoelectric drive. The graph shows the pressure effects of deuterium dissociation and ionization and radiation only to the degree that they are conserved and reversible in this reactor and demonstrates sufficient energy in the acoustic wave process to power the same.

I claim this invention to be:

1. A nuclear fusion reactor comprising:
a spherical reaction chamber with a mirrored interior surface filled with a nuclear fusible gas medium that is also a laser medium with
means to produce a spherical acoustic wave pattern centered within the reaction chamber to produce
intense acoustic compressions with subsequent radiation at the center of the chamber, sufficient to
synchronously produce a spherical laser pulse focused at this center causing ignition and fusion.

2. The reactor according to claim 1, relating to the means for producing a spherical acoustic wave pattern in one embodiment includes:
at least one external pulsed laser beam focused at the reactor chamber center through at least one window in the chamber wall used in unison with
a piezoelectric transducer assembly bonded to the interior surface of the chamber sphere wall.

3. The reactor according to claim 2, relating to the external pulsed focused laser beam includes:
at least one laser source with a means to pulse and focus the laser and
a laser window in the chamber sphere wall for transmission of each focused pulsed laser beam into the chamber.

4. The reactor according to claim 3, relating to the means to pulse and focus the laser includes:
a master controller to control a laser switching and/or pumping device using feedback directly from the laser or from a radiation sensor to time the laser pulses and their duration and
a lens to focus the pulsed beam at the reactor center, to create and intensify the acoustic waves by rapid heating and expansion, to provide
a spherical acoustic wave pattern centered within the chamber.

5. The reactor according to claim 2, relating to the piezoelectric transducer assembly includes:
a piezoelectric transducer assembly covering part or all of the available inner surface of the chamber sphere wall along with
a master controller using feedback from the piezoelectric transducer assembly or from an ultrasonic sensor to time the oscillations to create or intensify the wave to produce
a spherical acoustic wave pattern centered within the chamber.

6. The reactor according to claim 2 is further comprised of a plurality of sensors mounted in the chamber sphere wall at or near the inner surface of the chamber that includes:
thermal, ultrasonic, and radiation sensors to provide feedback to the master controller to adjust the laser drive and/or the piezoelectric drive and to keep heat and radiation within acceptable limits.

7. The reactor according to claim 1, in an alternate embodiment is comprised of only the laser drive as the means to produce the spherical acoustic wave pattern with
the accompanying sensors and master controller.

8. The reactor according to claim 1, in an alternate embodiment is comprised of only the piezoelectric drive as the means to produce the spherical acoustic wave pattern with
the accompanying sensors and master controller.

9. The reactor according to claim 1, further comprises:
a jacket surrounding the reaction chamber wall with at least one inlet and outlet port, filled with a pumped fluid for the purposes of
cooling the chamber wall and
capturing heat energy for the purpose of producing useful work or electricity.

10. The reactor according to claim 1, relating to the gas medium includes:
one or more gas source inlets and gas outlets, through the chamber wall, each with a gas diffuser at the inner surface of the chamber for replenishing the gas and exhausting partially used gas as well as a
gas source and pressure regulator on the gas inlet port and a vacuum pump on the gas outlet port to control pressure within the chamber.

11. The method of the reactor described in claim 1 consists of:
creating an energetic spherical acoustic wave, wave pattern, or standing wave pattern centered within the reaction chamber, that focuses and reinforces as a spherical wave, at the reactor center, of sufficient pressure and temperature to cause ionization and radiation to occur with subsequent population inversion and the creation of
a spherical laser pulse, again focused at the center area of dense gas, that produces
ignition and nuclear fusion.
